(19) United States
(12) Patent Application Publication
(10) Pub. No.: US 2014/0071039 A1
(43) Pub. Date: Mar. 13, 2014

(54) Electronic Apparatus and Display Control Method

(71) Applicant: Kabushiki Kaisha Toshiba, Tokyo (JP)

(72) Inventors: Kohji SAIKI, Kawasaki-shi (JP); Yuuji IRIMOTO, Fussa-shi (JP); Motonobu SUGIURA, Ome-shi (JP)

(73) Assignee: Kabushiki Kaisha Toshiba, Tokyo (JP)

(21) Appl. No.: 13/968,176

(22) Filed: Aug. 15, 2013

Related U.S. Application Data
(63) Continuation of application No. PCT/JP2013/059805, filed on Mar. 26, 2013.

(30) Foreign Application Priority Data
Sep. 7, 2012 (JP) 2012-197828

(51) Int. Cl. G09G 5/00

(52) U.S. Cl. CPC G09G 5/006
USPC 345/156

(57) ABSTRACT

According to one embodiment, an electronic apparatus includes at least one sensor, a display processor, and a determiner. The display processor displays a first image corresponding to first content data stored in a first folder on a screen. The determiner determines whether the electronic apparatus moves, using the at least one sensor. If it is determined that the electronic apparatus moves during display of the first image, the display processor displays, on the screen, an second image corresponding to second content data stored in another folder different from the first folder.

### CROSS-REFERENCE TO RELATED APPLICATIONS

This application is a Continuation application of PCT Application No. PCT/JP2013/059805, filed Mar. 26, 2013 and based upon and claiming the benefit of priority from Japanese Patent Application No. 2012-197828, filed Sep. 7, 2012, the entire contents of all of which are incorporated herein by reference.

### FIELD

Embodiments described herein relate generally to a content display control method.

### BACKGROUND

In recent years, various electronic apparatuses such as a tablet personal computer and personal computer (PC) have been developed. Most of electronic apparatuses of this type can fetch a content such as a photo from an external apparatus, and can save the content in an electronic apparatus.

An electronic apparatus can display the saved content on a screen of a display. Also, the electronic apparatus can transmit and receive a content with an on-line storage site via the Internet and the like. Furthermore, the electronic apparatus can transmit (upload) a content to an SNS (Social Network Service) site, and can receive a comment or the like for the uploaded content from the SNS site.

However, when a large number of contents are saved in the electronic apparatus, the user has to make an operation for finding out a desired content from the large number of contents. When the user wants to browse another content related to a certain content, he or she has to make an operation for finding out the related content. In this way, the user himself or herself has to make a troublesome operation required to find out a content, thus spending a lot of time. Also, realization of a novel function required to easily find out a content has been demanded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to one embodiment;

FIG. 2 is an exemplary view showing the overall configuration of a network to which the electronic apparatus according to the embodiment is connected;

FIG. 3 is an exemplary block diagram showing the system configuration of the electronic apparatus according to the embodiment;

FIG. 4 is an exemplary block diagram showing a content playback application executed by the electronic apparatus according to the embodiment;

FIG. 5 is an exemplary block diagram showing the detailed configuration of the content playback application executed by the electronic apparatus according to the embodiment;

FIG. 6 is an exemplary view for explaining an overview of the electronic apparatus according to the embodiment;

FIG. 7 is an exemplary flowchart showing the sequence of display control processing executed by the electronic apparatus according to the embodiment;

FIG. 8 is an exemplary view showing a timeline display screen of the content playback application program executed by the electronic apparatus according to the embodiment;

FIG. 9 is an exemplary view showing a thumbnail list display screen of the content playback application program executed by the electronic apparatus according to the embodiment;

FIG. 10 is an exemplary view showing a full display screen of the content playback application program executed by the electronic apparatus according to the embodiment;

FIG. 11 is an exemplary view showing a content switching screen of the content playback application program executed by the electronic apparatus according to the embodiment;

FIG. 12 is an exemplary view showing transitions of screens upon content switching of the content playback application program executed by the electronic apparatus according to the embodiment;

FIG. 13 is an exemplary view showing a screen which displays detailed information of a content displayed by the content playback application program executed by the electronic apparatus according to the embodiment;

FIG. 14 is an exemplary view showing a content import screen of the content playback application program executed by the electronic apparatus according to the embodiment; and

FIG. 15 is an exemplary view showing a content index information database table used by the electronic apparatus according to the embodiment.

### DETAILED DESCRIPTION

Various embodiments will be described hereinafter with reference to the accompanying drawings.

In general, according to one embodiment, an electronic apparatus includes at least one sensor, a display processor, and a determiner. The display processor displays a first image corresponding to first content data stored in a first folder on a screen. The determiner determines whether the electronic apparatus moves, using the at least one sensor. If it is determined that the electronic apparatus moves during display of the first image, the display processor displays, on the screen, an second image corresponding to second content data stored in another folder different from the first folder.

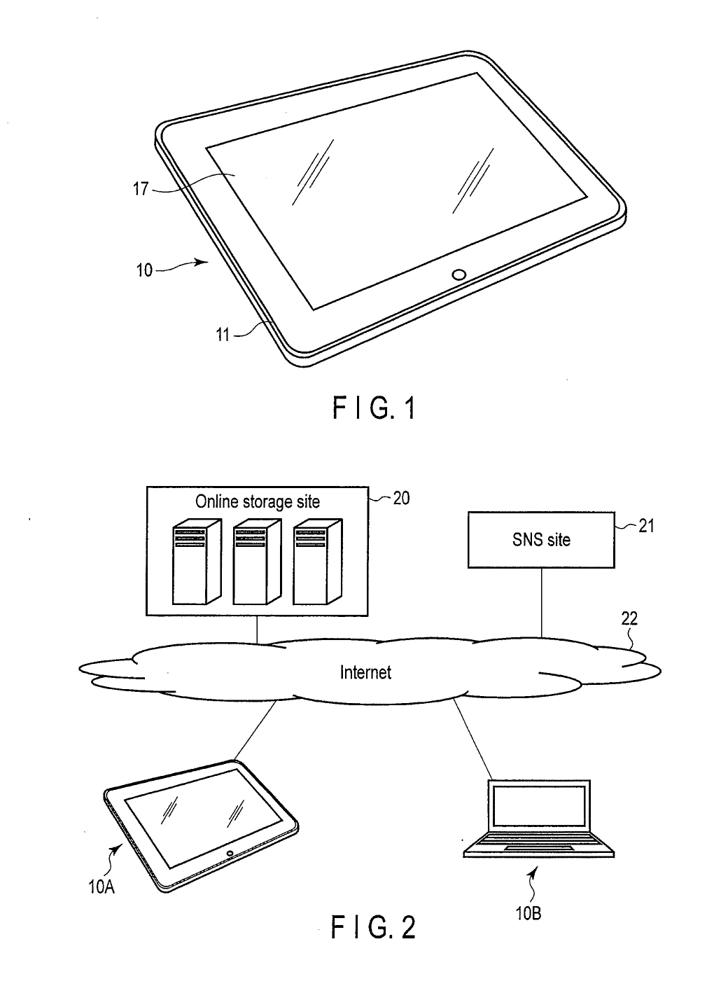

The configuration of an electronic apparatus according to one embedment will be described below with reference to FIG. 1. The electronic apparatus of this embodiment is implemented as a portable electronic apparatus, for example, a tablet computer 10. This electronic apparatus may be implemented as a notebook type personal computer, PDA, or the like.

The tablet computer 10 is configured by a computer main body 11 and touch screen display 17. The computer main body 11 includes a low-profile box-shaped housing. The touch screen display 17 is arranged on the surface of the computer main body 11. The touch screen display 17 includes a flat panel display (for example, a liquid crystal display device (LCD)) and touch panel. The touch panel is arranged to cover the screen of the LCD. The touch panel is configured to detect a position on the touch screen display 17, which is touched by the finger of the user or a pen. This tablet computer 10 has a content playback function required to efficiently sort out contents such as photos, and to allow the user to browse contents in a cheerful way and to share contents easily.

The system configuration of this embodiment will be described below with reference to FIG. 2.

Computers 10A and 10B are connected to an online storage site 20 and SNS site 21 via the Internet 22. Each of these computers 10A and 10B has the same content playback function as that of the tablet computer 10 of this embodiment.

The computers 10A and 10B can transmit and receive contents with the online storage site 20. The computers 10A and 10B can post contents on the SNS site 21.

Note that the computers 10A and 10B can transmit and receive various kinds of data such as contents via the Internet. Also, the computer 10B can transmit, to the SNS site 21, a comment about a content such as a photo posted from the computer 10A on the SNS site 21. The computer 10A can also receive comments to the content posted on the SNS site 21.

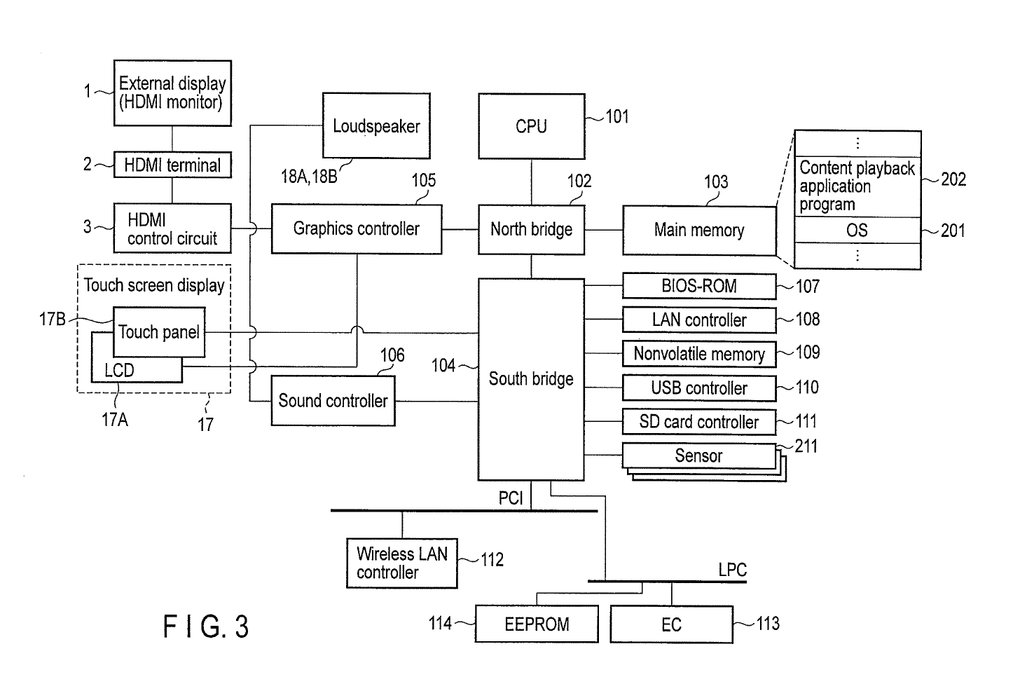

FIG. 3 shows the system configuration of the tablet computer 10.

The computer 10 includes a CPU (Central Processing Unit) 101, north bridge 102, main memory 103, south bridge 104, graphics controller 105, sound controller 106, BIOS-ROM 107, LAN (Local Area Network) controller 108, nonvolatile memory 109, USB controller 110, SD card controller 111, wireless LAN controller 112, EC (Embedded Controller) 113, EEPROM (Electrically Erasable Programmable ROM) 114, sensors 211, and the like.

The CPU 101 is a processor which controls the operations of respective modules in the computer 10. The CPU 101 executes various software programs loaded from the nonvolatile memory 109 onto the main memory 103. These software programs include an OS (Operating System) 201, content playback application program 202, and the like. The content playback application program 202 is a program configured to play back various contents received by a reception module such as the SD card controller 111, USB controller 110, or wireless LAN controller 112. The aforementioned contents include those which are received from a memory card via the SD card controller 112, those which are received from a USB memory, digital camera, or the like via the USB controller 110, those which are received from an external apparatus by the wireless LAN controller 112 via a wireless network, and the like.

The “content” is image (still image) data such as a photo, video (moving image) data, and the like. The content playback application program 202 has a function of playing back contents. The following description will be described under the assumption that a content (content data) is a photo. The content playback application program 202 is an application program, which efficiently sorts out photos, and allows the user to browse the sorted photos in a cheerful way. Also, the content playback application program 202 has a function of sharing the sorted photos with other users. The content playback application program 202 has a UI (User Interface) which allows the user to easily find out a photo, and to also find an unexpected photo.

The CPU 101 also executes a BIOS (Basic Input/Output System) stored in the BIOS-ROM 107. The BIOS is a program for hardware control.

The north bridge 102 is a bridge device which connects between a local bus of the CPU 101 and the south bridge 104. The north bridge 102 incorporates a memory controller which controls accesses to the main memory 103. The north bridge 102 has a function of executing communications with the graphics controller 105 via, for example, a PCI EXPRESS serial bus.

The GPU (graphics controller) 105 is a display controller, which controls the LCD 17 used as the display monitor of the computer 10. A display signal generated by this GPU 105 is sent to the LCD 17. Also, the GPU 105 can output a digital video signal to an external display 1 via an HDMI control circuit 3 and HDMI terminal 2.

The south bridge 104 controls respective devices on a PCI (Peripheral Component Interconnect) bus and respective devices on an LPC (Low Pin Count) bus. The south bridge 104 incorporates a nonvolatile memory controller to control the nonvolatile memory 109. Furthermore, the south bridge 104 has a function of executing communications with the sound controller 106.

The sound controller 106 is a sound source device, and outputs audio data to be played back to loudspeakers 18A and 18B. The wireless LAN controller 112 is a wireless communication device which executes wireless communications compliant with the IEEE802.11 standard. The wireless LAN controller 112 functions as a wireless communication module which receives a content from an external apparatus via a wireless LAN.

The EC 113 is an embedded controller for power management. The EC 113 has a function of turning on/off the power supply of the computer 10 in response to an operation of a power button by the user.

The sensors 211 can be those which can detect movements (tilting, shaking, and the like of the computer 10) of the computer 10. The sensors 211 include, for example, an acceleration sensor, gyroscope, compass, proximity sensor, and illuminance sensor. The acceleration sensor can detect a movement of the computer 10 based on an acceleration which changes when the main body 11 of the computer 10 has been shaken. The gyroscope can detect a movement of the computer 10 based on a tilt of the computer 10. The compass can detect a movement of the computer 10 based on an azimuth direction (east, west, south, north, and the like) of the computer 10. The proximity sensor can detect a movement of the computer 10 when the computer 10 comes close to an external object. The illuminance sensor can detect a movement of the computer 10 based on a change in illuminance. The illuminance sensor detects light (illuminance) around the computer 10. For example, when the computer 10 is a notebook type computer which includes a main body and a display rotatably attached to the main body, the illuminance sensor may be disposed on the top surface of the main body or the front surface of the display. When the display of the computer 10 is opened/closed, the illuminance sensor can detect a movement (opening/closing of the display) of the computer 10 based on a change in light (illuminance) around the computer 10.

Note that “date” in the following description means “year”, “month”, “day”, “time”, “day of the week”, or the like unless otherwise specified. A date associated with certain content is a date imported from a memory card or the like to the computer 10, a date of creation of the content, or the like. When the content is a photo, the date of creation of the content corresponds to a photographing date of the photo. Also, as for a date associated with an “SNS album” to be described later, a date of posting of the content on the SNS site 21 can be used.

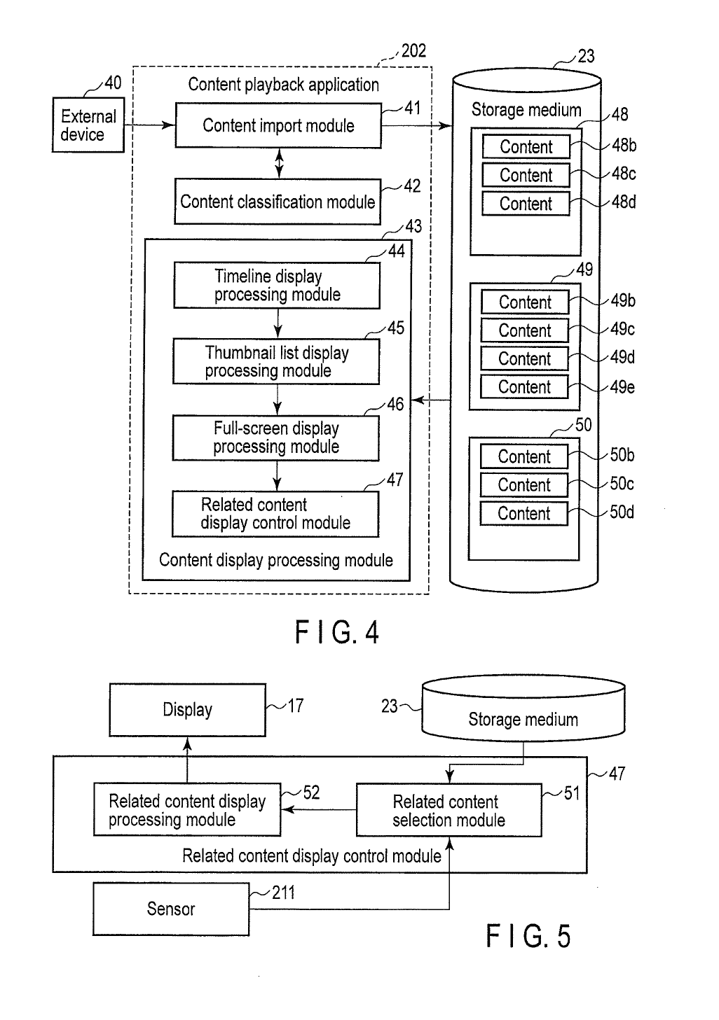

The functional configuration of the content playback application program 202 will be described below with reference to FIG. 4.

The content playback application program 202 includes a content import module 41, content classification module 42, and content display processing module 43. Functional blocks (content import module 41, content classification module 42, content display processing module 43, and the like) included in the content playback application 202 are implemented when the CPU 101 executes the content playback application 202.

The content import module 41 imports a content from an external device 40 (for example, a memory card, digital camera, or the like) to the computer 10. The content import module 41 sends the imported content to the content classification module 42 to classify the imported content by a predetermined classification method. The content import module 41 receives the content classified by the content classification module 42, and stores the received content in a storage medium 23.

The content classification module 42 classifies a content sent from the content import module 41 by the predetermined classification method. As the classification method of contents, for example, that for classifying contents for respective directories (folders), that for classifying contents using date information (for example, date information embedded in photos), or that for classifying contents using dates of posting on a cloud service such as an SNS site, and the like can be used.

Furthermore, as for classification of photos, the following classification method can also be used.

The content classification module 42 can classify contents using a clustering technique with reference to faces, smiles, or landscapes included in photos. The clustering technique uses, for example, information appended to photos. In the clustering technique using detection of a face, a face is detected from objects, and feature amounts of the detected face are calculated. The feature amounts are amounts of pieces of information such as a face position, size, degree of smiling, degree of sharpness, and frontal degree. Note that face detection and feature amount calculations (face recognition) are applied to all photos to combine photos including faces of similar features into one group. Thus, person-dependent grouping can be executed. In the clustering technique (scene recognition) using detection of a landscape (scene) of a photo, a principal object other than face is recognized from objects of a photo. By combining the recognized objects and face recognition results, photos can be classified based on scenes of objects. The recognizable scenes include, for example, landscapes, flowers, buildings, dishes, vehicles, and the like. By combining the scene recognition with the face recognition, family photos and group photos can be recognized. The landscapes can be further finely classified into sea, fall foliage, snow, city, Japanese-style house, night scene, on the road, and the like based on their features. By adding pieces of face information or scene information recognizable by the face recognition or scene recognition to a database in the computer 10, the number of recognizable faces or scenes can be increased. Using such clustering technique, photos can be grouped based on types of their objects and the like.

A set of a plurality of contents classified into a single group by the content classification module 42 is called a content group or album. A plurality of contents which belong to a single content group is associated with a certain common period. For example, if a plurality of photos which were taken during a certain trip form one content group, a period corresponding to the period of this trip is associated with these plurality of photos. On the other hand, when a plurality of photos imported to the computer 10 on the same day form one content group, a period corresponding to this import day is associated with these plurality of photos. A plurality of different content groups obtained by the classification processing of the content classification module 42 may be respectively stored in a plurality of different folders on the storage medium 23.

The content display processing module 43 includes a timeline display processing module 44, thumbnail list display processing module 45, full-screen display processing module 46, and related content display control module 47. The content display processing module 43 functions as display processor configured to execute processing to display a content stored in the storage medium 23 on the display 17.

The timeline display processing module 44 performs processing for executing a function (timeline display function) of simultaneously displaying, in a chronological order, a plurality of content groups, which are classified by different classification method, on, for example, a line (timeline) indicating the time axis.

The thumbnail list display processing module 45 performs processing for executing a function (list display function) of displaying a list of images respectively corresponding to contents included in a content group selected by a user from the plurality of content groups displayed by the timeline display function. With the list display function, a plurality of thumbnails (a plurality of thumbnail images) corresponding to a plurality of contents included in the selected content group are displayed.

The full-screen display processing module 46 performs processing for displaying, on the display 17 in a full-screen mode, one content corresponding to a certain thumbnail selected by the user from the plurality of thumbnails displayed by the list display function.

The related content display control module 47 performs processing for displaying (related content display function), on the display 17, a content related to the content displayed in the full-screen mode by the full-screen display processing module 46. The related content is a content related to the currently displayed content. The related content need only be that related to the content currently displayed by the full-screen display processing module 46. The related content is not limited to a content including any of the same or similar photographing date, photographing location, photographing target, included persons, creator, and the like, but it may be a content stored in another folder different from a folder which stores the currently displayed content.

In the storage medium 23, a plurality of contents are stored in each of a plurality of folders.

FIG. 4 shows three folders. The three folders are folders 48, 49, and 50. The folder 48 stores three contents. The three contents in the folder 48 are contents 48b, 48c, and 48d. These contents 48b, 48c, and 48d may be those which belong to a certain same content group. Likewise, the folder 49 stores four contents. The four contents in the folder 49 are contents 49b, 49c, 49d, and 49e. These contents 49b, 49c, 49d, and 49e may be those which belong to a certain same content group. The folder 50 stores three contents. The three contents in the folder 50 are contents 50b, 50c, and 50d. These contents 50b, 50c, and 50d may be those which belong to a certain same content group.

Note that FIG. 4 shows the case in which one folder stores a plurality of contents. However, one folder can store only one content.

Also, the content import module 41 receives a content sent from the online storage site 20. For example, it is assumed the case that a content to be displayed on the display 17 is not stored in the storage medium 23, more specifically, the computer 10 holds information (for example, metadata or the like) associated with the content, but the content itself is stored in the online storage site 20. In this case, when that content is to be displayed on the display 17, the content import module 41 may execute processing for importing that content from the online storage site 20.

The detailed system configuration of the related content display control module 47 will be described below with reference to FIG. 5.

The related content display control module 47 includes a related content selection module 51 and related content display processing module 52.

The related content selection module 51 functions a determiner configured to determine whether movement of the computer 10 moves. The related content selection module 51 determine based on sensor values (detection values) sent from the sensors 211 whether or not a related content is to be selected, that is, the presence/absence of a predetermined movement of the computer 10. If it is determined based on the detection values of the sensors 211 that movement of the computer 10 has moved, the related content display control module 47 selects a related content from those stored in the storage medium 23. For example, it is assumed the case that the user has performed a predetermined operation by, for example, shaking the computer 10, and values of the plurality of sensors (e.g., first sensor and second sensor) have exceeded thresholds. In this case, the related content selection module 51 can select a first related content using a first selection criterion (attribute) corresponding to the first sensor, and can select a second related content using a second selection criterion (attribute) corresponding to the second sensor. The related content selection module 51 sends the selected related content to the related content display processing module 52.

The related content display processing module 52 executes processing to display the related content received from the related content selection module 51 on the display 17. The related content display processing module 52 can also display, on the display 17 at the same timing, a plurality of different related contents selected by the related content selection module 51 using a plurality of different selection criteria.

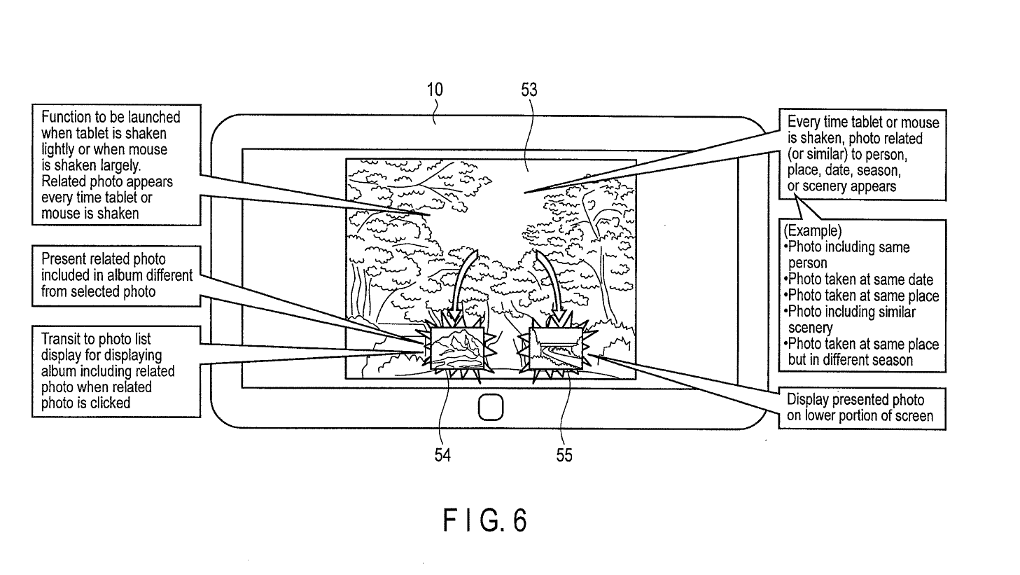

An overview of this embodiment will be described below with reference to FIG. 6. Note that FIG. 6 will assume a case in which a content group is an album including photos. However, a content is not limited to a photo, and may be the aforementioned content.

FIG. 6 shows an example of a related content display screen which is displayed by the content playback application program 202 on the display 17 in the computer 10. The display 17 displays a photo as a “main” photo in a full-screen mode. For example, when the computer 10 has been shaken, a related content display function is launched. In FIG. 6, a photo (related photo) related to the main photo is displayed as a related content on a lower portion of the display 17. Note that every time the computer 10 is shaken, a new related photo is selected, and the selected related photo is displayed on the display 17.

In response to a predetermined operation (for example, shaking of the computer 10, large shaking of a mouse, or the like), the related content display function is launched. Every time the predetermined operation is performed, for example, every time the computer 10 is shaken, a related photo appears like a related photo 54 or 55 in FIG. 6. The related photo which appears every time the predetermined operation is performed is that related to a main photo 53. Also, the related photo is that which is related (or similar) to a person, place, date, season, scenery, or the like associated with the main photo 53. For example, the related photo is a photo including the same person as the person included in the main photo 53, that which was taken on the same day as the day of photographing of the main photo 53, that which was taken at the same place as the photographing place of the main photo 53, that including a scenery similar to that of the main photo 53, or that which was taken at the same place as the photographing place of the main photo 53 but in a season different from that of the main photo 53.

A related photo which is included in an album which is different from that storing the main photo 53 selected by the user or the like may be presented on the lower portion of the screen as the related photo 54 or 55. In this case, the related photo 54 and 55 are photos which are stored the album (folder) different from the album (folder) storing the main photo 53 and are photos related to the main photo 53.

When the user selects the related photo 54 or 55 by, for example, a click operation, the related content display screen transits to a thumbnail list display screen, which displays an album including the related photo as a list of photos.

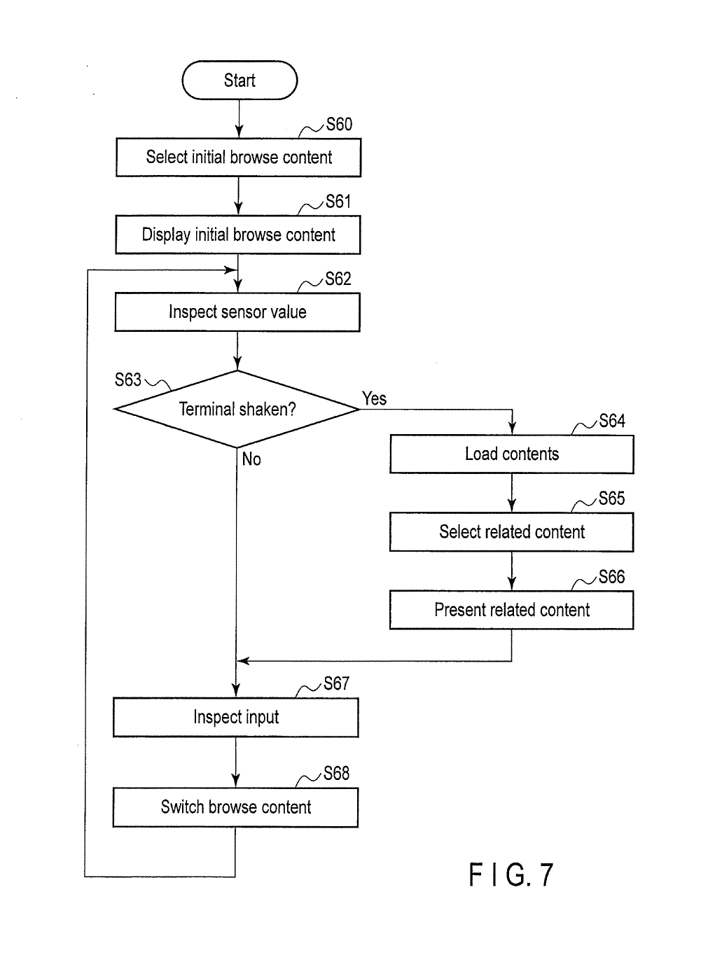

The sequence of content switching processing in the content playback application 202 will be described below with reference to FIG. 7.

Initially, the content playback application 202 selects an initial browse content (step S60). The initial browse content is that corresponding to a starting point in the processing of FIG. 7, and that also as a reference upon selection of a related content. The initial browse content is, for example, the main photo 53 in FIG. 6. The initial browse content can be arbitrarily selected from those stored in the storage medium 23. Then, the selected initial browse content is displayed on the screen (step S61).

Next, the content playback application 202 inspects the values of the sensors 211 (step S62). The values of the sensors 211 are those obtained by the aforementioned sensors 211. Note that the values of the sensors 211 to be inspected in step S62 may be those of either all or some of the sensors included in the computer 10.

Then, the content playback application 202 determines based on the values of the sensors whether or not the computer 10 has been shaken (step S63). For example, when a change in value of the acceleration sensor, which has exceeded a threshold, is repeated the predetermined number of times, it can be determined (considered) that the computer 10 has been shaken. Also, when a change in tilt of the computer 10, which is detected by the gyroscope and has exceeded a threshold, is repeated the predetermined number of times, it can be determined (considered) that the computer 10 has been shaken. When the values of the plurality of sensors are to be inspected, if it is determined based on at least one sensor that the shaking operation has been detected, it can be determined that the computer 10 has been shaken. When accelerations corresponding to a plurality of axes (three axes, that is, X-, Y-, and Z-axes) can be detected like the acceleration sensor, if a value for at least one axis has exceeded a threshold, it can be determined that the computer 10 has been shaken. If it is determined in step S63 that the computer 10 has not been shaken (NO in step S63), the process advances to step S67.

If it is determined in step S63 that the computer 10 has been shaken (YES in step S63), the content playback application 202 loads contents from the storage medium 23 (step S64).

The content playback application 202 then selects a related content, which is related to the currently browsed content, from the loaded contents (step S65). The related content is selected for, for example, each type of the sensor 211 to be inspected in step S62. Alternatively, the related content may be selected for each parameter such as an axis of each sensor 211. Therefore, related contents as many as the sum of the number of types of sensors 211 and the number of parameter of respective sensors can be selected. For example, for the sensor 211 which detects an acceleration in a direction perpendicular to the long side of the screen, a content corresponding a date close to that of the currently browsed content can be selected as a related content. Also, for example, for the sensor 211 which detects an acceleration in a direction parallel to the long side of the screen, a content which was acquired at the same place as that where the currently browsed content was acquired can be selected as a related content. Furthermore, the number of related contents to be selected may be increased according to the value of each sensor 211. For example, as a degree of tilt of the main body 11 at the detection timing of shaking of the computer 10 becomes larger than a predetermined value, the number of related contents to be selected can be increased. As another example, the number of related contents to be selected can be increased as the value of the acceleration sensor becomes larger than a predetermined value.

The content playback application 202 then displays (presents) the related contents selected in step S65 (step S66). Note that in step S66, the content playback application 202 may control the display fashion of the related contents on the screen based on the values of the sensors 211. For example, based on the values of the sensors 211, the content playback application 202 can change a display speed of each related content (i.e., motion speed of each related content), a time period required until each related content is displayed at a predetermined position on the screen, or a motion of each related content on the screen (animation display). The content playback application 202 can display the related contents using the changed display speed, the changed time period, or the changed motion.

The content playback application 202 inspects an input from a mouse, keyboard, or the like (step S67). The input from the mouse, keyboard, or the like is that required to switch the currently browsed content. The input is generated when the user moves the mouse to switch the currently browsed content.

As a result of inspection of the input from the mouse, keyboard, or the like, if the input required to switch the content is detected, for example, if any of the related contents presented in step S66 is selected, the content playback application 202 displays that related content in the full-screen mode to switch the currently browsed content (step S68). Note that the content which is switched and displayed in step S68 is that corresponding to the next reference upon selection of related contents.

After the content to be browsed is switched in step S68, the process returns to step S62 to inspect the values of the sensors 211 again.

Note that the currently browsed content and related contents may be displayed to allow the user to recognize the relationship in which the currently browsed content is a “main” content, and the related contents are “slave” contents. For example, the currently browsed content is displayed in the full-screen mode, and the related contents are displayed to have a small size on corners or the like of the screen.

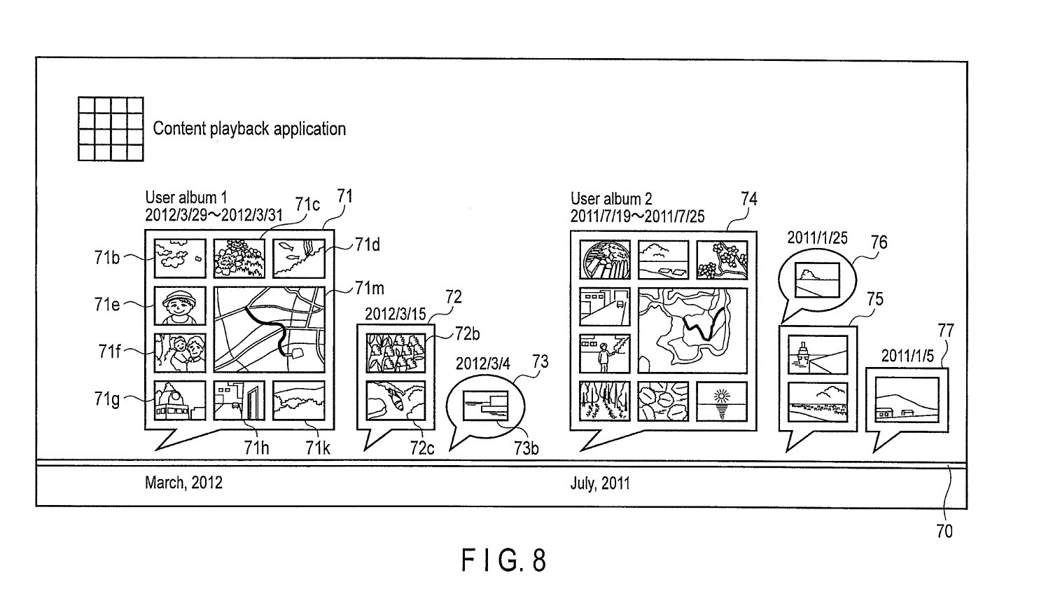

An example of the timeline display screen displayed by the content playback application program 202 will be described below with reference to FIG. 8.

Terms and the like required to explain the timeline display screen will be described first.

In this embodiment, as types of content groups, a user album, date album, and SNS album can be used. These albums of the three types, that is, the user album, date album, and SNS album are content groups of three types, which are classified by the three classification methods which are different from each other.

The user album includes a set of specific contents selected by the user. The date album includes a set of contents at a predetermined date. The SNS album includes a set of contents posted on the SNS site 21.

On the timeline display screen, respective albums are displayed as objects corresponding to respective albums. The object may be one which allows the user to recognize that a plurality of contents belong to the same content group. For example, a frame having a predetermined display fashion (for example, a frame having a rectangular shape, that having an oval shape, or the like), a region filled with a color different from a background color, or the like can be used as the object. The object can include at least an image display region. The image display region is a region that can display one or more images. On an image display region in an object corresponding to a certain content group, a plurality of images corresponding to a plurality of contents which belong to the certain content group may be displayed. In this case, the content display processing module 43 can sequentially display, on an image display region, a plurality of images corresponding to a plurality of contents which belong to a content group. Thus, since images to be displayed on the image display region are switched among the plurality of images corresponding to the plurality of contents, the display content of the image display region changes along with an elapse of time. In this way, the content display processing module 43 can display as switching, in the image display region, a plurality of images corresponding to a plurality of contents which belong to the same content group. Thus, what kinds of contents in the content group are grouped can be plainly presented to the user.

As types of image display regions in an object, two types, that is, “photo tile” and “map tile” can be used. “Photo tile” is an image display region used to display an image such as a photo. “Map tile” is an image display region used to display a map associated with the corresponding content group.

Note that the display fashion of an object may be changed according to the classification method. Now a case will be assumed wherein a plurality of contents which belong to a first content group are classified into the first content group by a first classification method, and a plurality of contents which belong to a second content group are classified into the second content group by a second classification method. In this case, the content display processing module 43 generates an object having a first display fashion corresponding to the first classification method as an object corresponding to the first content group. Also, the content display processing module 43 generates an object having a second display fashion, which corresponds to the second classification method and is different from the first display fashion, as an object corresponding to the second content group. Thus, the objects having different display fashions can be respectively displayed on a single timeline display screen in a chronological order. Furthermore, the content display processing module 43 can change a display fashion of an object according to an information amount (for example, the number of contents) of a corresponding content group. For example, the content display processing module 43 can change the number of image display regions displayed within an object according to the number of contents included in a corresponding content group, and can change a size of the object according to the number of image display regions.

The content display processing module 43 specifies a point of time corresponding to a content group (to be simply referred to as a representative point of time hereinafter). The representative point of time is not particularly limited as long as a point of time corresponds to a content group. For example, the latest date of a plurality of dates corresponding to a plurality of contents in a content group may be decided as a representative point of time. The representative point of time is the latest date, oldest date, an intermediate date between the oldest and latest date, a date corresponding to content which appears most frequently in a content group, or a period to be defined by these dates.

The timeline display screen will be described in detail below with reference to FIG. 8. Note that the following description will be assumed under the assumption that a content group is an album including photos. However, a content is not limited to a photo, and may be the aforementioned content.

The timeline display screen is an initial display screen when the content playback application 202 is launched, and is also a screen corresponding to a starting point to respective display modes of a thumbnail list display screen, full display screen, and the like (to be described later). The timeline display screen is used to display a plurality of objects corresponding to a plurality of albums along the time axis.

A timeline 70 which is displayed on the lower portion of the timeline display screen represents the time axis, and objects corresponding to respective albums are displayed as frames each having, for example, a balloon. Also, below the timeline 70, labels each of which displays “year” and “month” are displayed. The user can browse objects corresponding to respective albums by going back time from the left side to the right side in FIG. 8. By scrolling the timeline display screen to the right side, objects of older albums are displayed. Note that the timeline 70 shown in FIG. 8 may not be displayed. When the time axis is not displayed, objects corresponding to albums may be displayed to be arranged in a chronological order with respect to a predetermined direction.

On the timeline display screen, an object corresponding to each album is displayed in the display fashion such as a balloon, as described above. One or more photo tiles are displayed in the object corresponding to each album. On photo tiles, a plurality of thumbnails corresponding to a plurality of photos included in the same album are displayed while being switched in turn (slideshow). Thus, photos included in each album can be presented to the user.

More specifically, in FIG. 8, seven objects 71 to 77 are arranged in a chronological order. The object 71 represents a user album 1, the object 72 represents a date album, the object 73 represents an SNS album, and the object 74 represents a user album 2. Furthermore, the object 75 represents another date album, the object 76 represents another SNS album, and the object 77 represents still another date album.

The object 71 of the user album 1 includes eight small photo tiles 71b to 71k, and one large map tile 71m.

The object 71 of the user album 1 is displayed in association with a position on the timeline 70 in correspondence with a representative point of time of the user album 1. More specifically, the object 71 of the user album 1 is a rectangular frame having a triangular projection, and is displayed so that the triangular projection points to a position corresponding to “March, 2012” on the timeline 70 as the representative point of time of the user album 1. Also, “user album 1” as a title of the user album 1, and a photographing period corresponding to a plurality of photos in the user album 1 are displayed above the object 71.

The period displayed above the object 71 of the user album 1 indicates that between the latest date and the oldest date of photographing dates corresponding to the photos included in the user album 1. Note that this period includes the aforementioned representative point of time. In FIG. 8, the period of the user album 1 is displayed like “2012/3/29 to 2012/3/31”. In this way, the timeline display processing module 44 groups photos taken during a predetermined period, and displays the photos as a photo group corresponding to one representative point of time in place of simply arranging a plurality of photos taken on different dates in a chronological order.

As for the date album, the object 72 of the date album is displayed in association with a position on the timeline 70 in correspondence with a representative point of time of this date album. More specifically, the object 72 of the date album is a rectangular frame having a triangular projection, and is displayed so that the triangular projection points to a position of the timeline 70 corresponding to the representative point of time of the date album. The object 72 includes two photo tiles 72b and 72c.

As for the SNS album, the display object 73 of the SNS album is displayed in associated with a position on the timeline 70 corresponding to a representative point of time of this SNS album. More specifically, the display object 73 of the SNS album is an oval frame having a triangular projection, and is displayed so that the triangular projection points to a position on the timeline 70 corresponding to the representative point of time of the SNS album. The object 73 includes one photo tile 73b.

When a representative date corresponding to a certain date album is the same as that corresponding to a certain SNS album, the object 75 corresponding to that date album and the object 76 corresponding to that SNS album are displayed with being stacked at the same position on the timeline 70, as shown in FIG. 8.

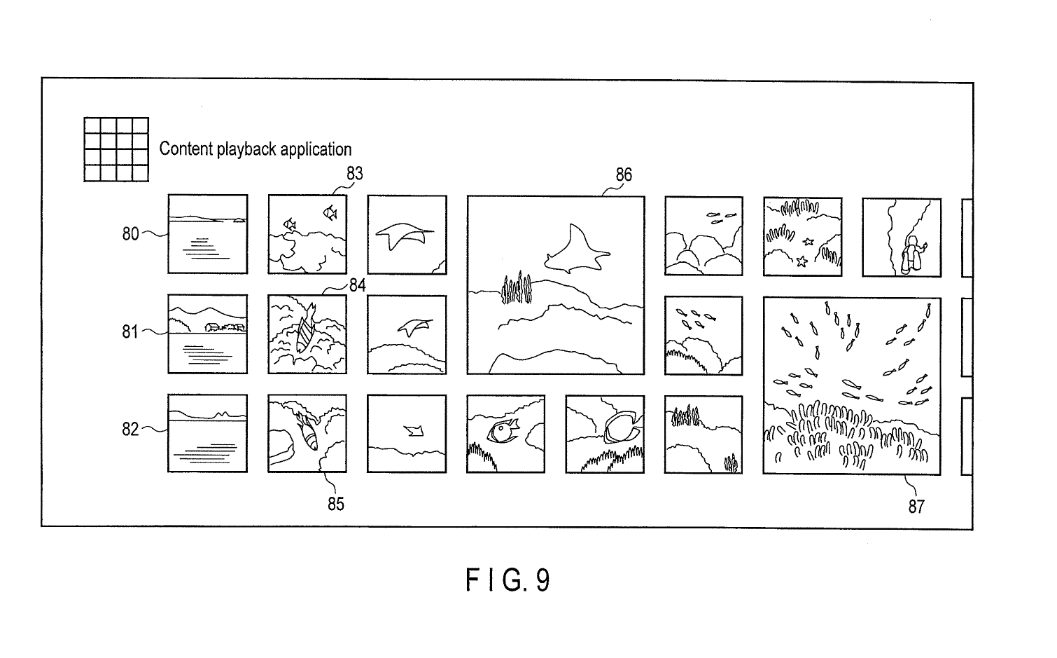

An example of the thumbnail list display screen will be described below with reference to FIG. 9. Note that the display 17 will also be referred to as a screen hereinafter.

FIG. 9 shows the thumbnail list display screen. The thumbnail list display screen displays a list of thumbnails of a plurality of photos in an album corresponding to an object selected from a plurality of objects displayed on the timeline display screen shown in FIG. 8. For example, when the user selects the object 71 on the timeline display screen shown in FIG. 8, a plurality of thumbnails corresponding to a plurality of photos in the user album 1 corresponding to the object 71 are displayed on the thumbnail list display screen. On the thumbnail list display screen shown in FIG. 9, thumbnails are arranged in turn from an upper left corner and from one having the latest photographing date of a photo. For example, a thumbnail 80 corresponds to a photo corresponding to a later photographing date than those of a photo corresponding to a thumbnail 81 or 83. The thumbnail 81 corresponds to a photo, the photographing date of which is later than the photo corresponding to the thumbnail 82. Note that either of the photographing date of a photo corresponding to the thumbnail 82 or that of a photo corresponding to the thumbnail 83 may be later.

Some of thumbnails are displayed to have a size for four thumbnails, and photos in the same album are displayed in a slideshow mode. Thumbnails 86 and 87 are those having a size for four thumbnails.

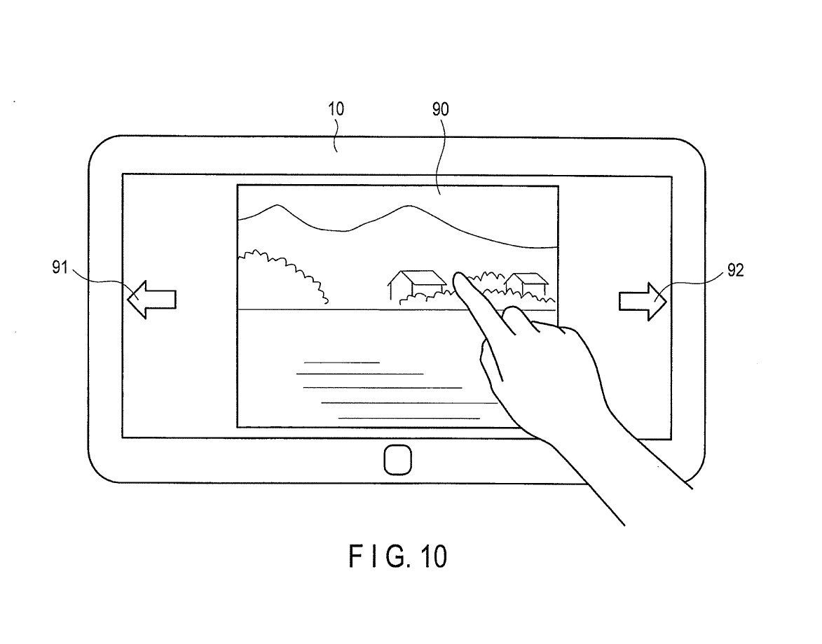

By selecting a thumbnail or that on which a slideshow is displayed by, for example, clicking, a photo corresponding to the selected thumbnail can be displayed in a full-screen mode, as shown in FIG. 10. Note that by making, for example, a pinch-out operation on the touch panel 17B in place of clicking on the thumbnail, a photo corresponding to the selected thumbnail is displayed in the full-screen mode. In this case, a photo corresponding to a thumbnail near the central point where the pinch-out operation is performed is displayed in the full-screen mode.

Note that a slideshow may be made for the thumbnails 80 to 85 other than the thumbnails 86 and 87. The user may set a time interval, effect, and the like of the slideshow. Also, the size of each thumbnail and the number of rows of thumbnails may be changed according to the resolution of the screen. For example, FIG. 9 shows a case in which the number of rows of thumbnails is 3. Furthermore, in order to allow the user to recognize what kind of an album including the photos is displayed on the thumbnail list display screen, an album title may be displayed by assuring, for example, an album title display region.

In place of an album displayed on the timeline display screen, for example, photos corresponding to a specific date on a calendar may be displayed in a list using a calendar function included in the content playback application 202. Furthermore, photos taken at a specific location displayed on a map displayed on the timeline display screen may be displayed as a list.

An overview of a full-screen display operation in the content playback application 202 will be described below with reference to FIG. 10.

The content playback application 202 displays a photo corresponding to a thumbnail selected on the thumbnail list display screen shown in FIG. 9 in a full-screen mode (full-screen display). The full-screen display means to display an image of a photo in an enlarged scale. Note that the full-screen display is to display the entire photo on the screen as large as possible. In this case, the entire photo need not always be displayed, and a portion of the enlarged photo to have a large size may be displayed on the screen.

By the user flicks or makes a keyboard operation or a mouse operation in a direction (right-and-left direction) denoted by reference numeral 91 or 92, a photo to be displayed in the full-screen mode can be switched to that in the same folder before or after a photo 90 which is currently displayed in the full-screen mode. That is, The photo to be displayed in the full-screen mode can be switched to a photo before or after the photo 90 in the same album (the same content group) as the photo 90. Note that FIG. 10 shows the full display screen when the thumbnail 81 in FIG. 9 is selected.

When the user flicks in the direction 92, the content playback application 202 switches the photo 90 to a photo corresponding to an older date than date of the photo 90, and displays that photo in the full-screen mode. When the user flicks in the direction 91, the content playback application 202 switches the photo 90 to a photo corresponding to a later date than date of the photo 90, and displays that photo in the full-screen mode.

When the user makes, for example, a mouse operation, mouse switching buttons used to switch a photo are displayed on the two ends on the screen. When the user selects the mouse switching button by operating a mouse, the photo 90, which is currently displayed in the full-screen mode, can be switched to that in the same folder before or after the photo 90. Note that a photo before or after the currently displayed photo in the same folder is that displayed on the thumbnail list display screen shown in FIG. 9. The direction to flick is not limited to the right-and-left direction, but it may be, for example, a direction (up-and-down direction) perpendicular to the right-and-left direction.

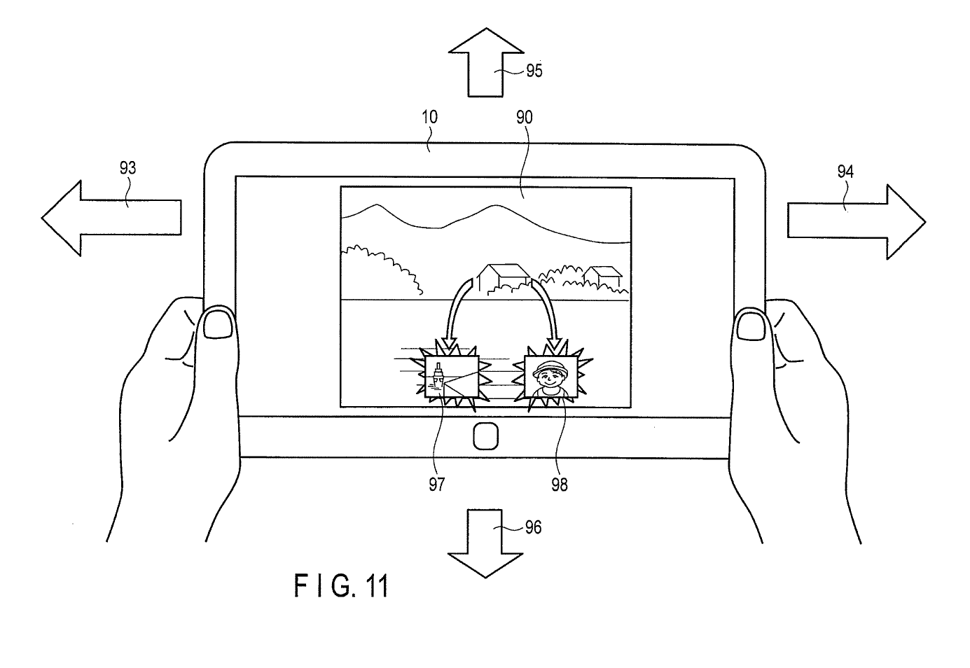

A screen used to switch contents of the content playback application program 202 will be described below with reference to FIG. 11.

When a photo 90 is displayed on the screen as a main photo and the user makes a predetermined operation, a related photo 97 or 98, which is related to the photo 90, is displayed.

The predetermined operation includes an operation for shaking the computer 10, that for tilting the computer 10, that for turning the computer 10, that for bringing the computer 10 to be closer to a predetermined object, and the like. The operation for shaking the computer 10 includes an operation for shaking the computer 10 in directions 93 and 94 in FIG. 11, that for shaking the computer 10 in directions 95 and 96, that for shaking the computer 10 in directions perpendicular to the surface of the display 17, and the like. The operation for turning the computer 10 includes an operation for turning the computer 10 to have the directions 93 and 94 as an axis which pass the center of the display 17, that for turning the computer 10 to have the directions 95 and 96 as an axis which pass the center of the display 17, that for turning the computer 10 to have the directions as an axis which are perpendicular to the surface of the display 17 and pass the center of the display 17, or the like. Note that such predetermined operation is that which can be detected by the sensors 211. By the computer 10 has been shaken, for example, in one direction, it can be determined that the computer 10 has been moved. When the user makes a first predetermined operation while the photo 90 is displayed, a related content is displayed in association with a first selection criterion (attribute). After that, when the user makes a second predetermined operation different from the first predetermined operation, a related content is displayed in association with a second selection criterion (attribute).

A motion (animation operation) until the related photo 97 or 98 is displayed at display position of the related photo 97 or 98 on the screen (to be also referred to as a related photo position hereinafter) will be described below. The animation operation includes an operation for dropping the related photo from the center of the screen to the lower portion of the screen, that for moving the related photo from the right, left, upper, or lower side of the screen to the related photo position, that for gradually reducing a size of the related photo displayed in an enlarged scale to a size of the related photo 97 or 98 as shown in FIG. 11, or the like. Also, an operation for repeating for the related photo, for example, that for rotating the related photo or that for oscillating (shaking) the related photo in the right-and-left direction or up-and-down direction, may be performed during movement of the related photo to the related photo position.

FIG. 11 shows the two related photos, that is, the related photos 97 and 98. However, one related photo or three or more related photos may be displayed on the screen. Also, every time the predetermined operation is performed, the number of related photos to be displayed on the screen can be increased. For example, when the photo 90 is displayed, and the related photos 97 and 98 are not displayed, the predetermined operation is performed to display the related photo 97. After that, when the predetermined operation is performed again, the related photo 98 is displayed. After that, when predetermined operations are further performed, other related photos may be displayed together with the related photos 97 and 98 while the related photos 97 and 98 are kept displayed.

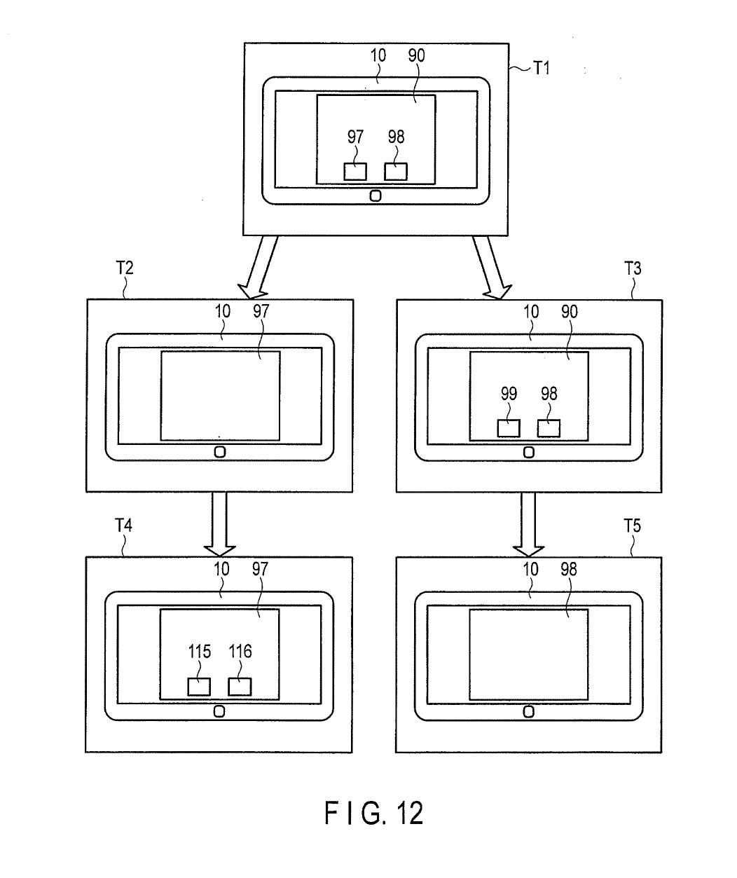

An example of screen transitions will be described below with reference to FIG. 12.

In a state T1, one main photo and two related photos are displayed on the screen as in FIG. 11. When the related photo 97 is selected in the state T1, a screen transits to a state T2.

In the state T2, the selected related photo 97 is displayed in the full-screen mode. When the aforementioned predetermined operation is performed in the state T2, related photos 115 and 116, which are related to the related photo 97 displayed in the full-screen mode, are displayed on the screen.

In a state T4, the related photos 115 and 116, which are related to the related photo 97 displayed in the full-screen mode, are displayed on the screen. On the other hand, a state T3 indicates a state when the predetermined operation is performed without selecting the related photo 97 or 98 in the state T1.

In the state T3, a related photo 99, which is related to the photo 90 displayed in the full-screen mode, is displayed at a position where the related photo 98 was displayed. In the state T3, the related photo 99 is displayed together with the related photo 97.

A state T5 indicates a sate when the related photo 98 is selected in the state T3. When the related photo 98 is selected, the related photo 98 is displayed in the full-screen mode.

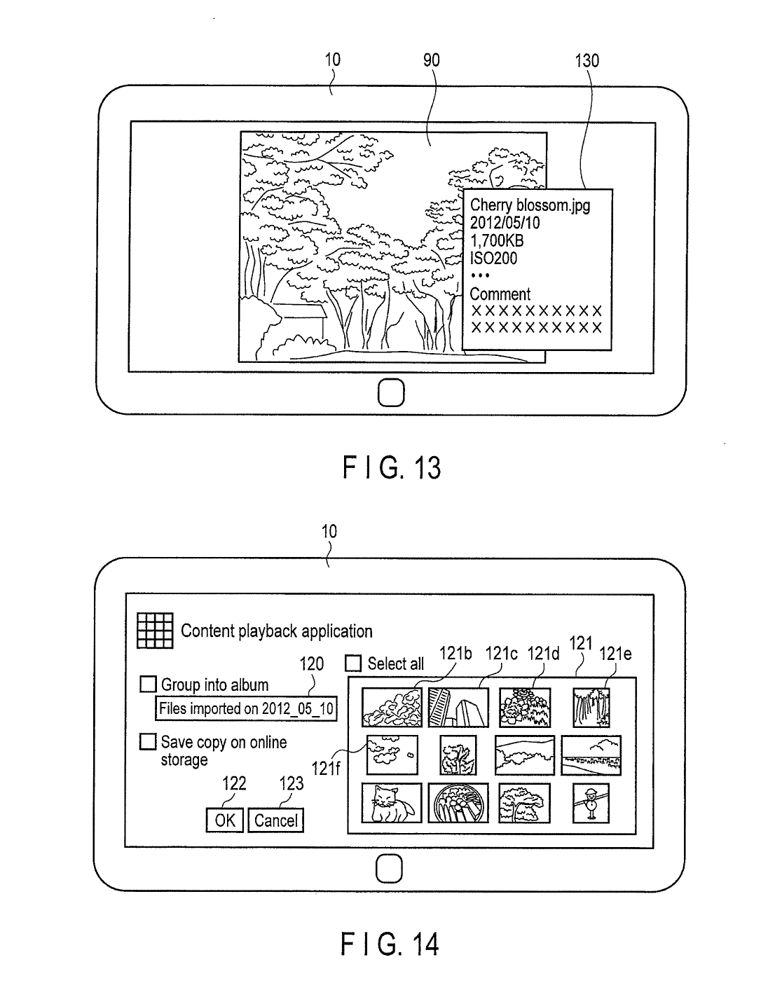

A display example of information of a currently browsed photo will be described below with reference to FIG. 13.

For example, when the user selects the photo 90, which is currently displayed in the full-screen mode, by, for example, clicking, a photo detailed information screen 130 shown in FIG. 13 is displayed. The photo detailed information screen 130 displays a file name “cherry blossom.jpg” of the photo 90, a date “2012/05/10” of the photo 90, a file size “1,700 KB” of the photo 90, a comment associated with the photo 90, which is input by the user or the like, and so forth.

An example of a screen displayed upon importing a photo will be described below with reference to FIG. 14.

A case will be assumed wherein an external device is connected to the computer 10, and the connected external device is presented by the OS 201. In such case, when the user selects the content playback application 202 from a list used to select an application to be launched for the connected external device, an “import from external device” screen is displayed, as shown in FIG. 14.

The content playback application 202 can import all detected photos or some photos selected from the detected photos to a photo folder. In FIG. 14, photos detected from the external device are displayed as thumbnail images 121b to 121f in a list on an “import from external device” screen. Note that the photo folder is a folder used to save photos. The photo folder corresponds to, for example, the folder 48, 49, or 50 shown in FIG. 4.

When the content playback application 202 imports photos, and when the user checks a check box “group into album”, a user album can be created. When the user does not check the check box “group into album”, the content playback application 202 classifies, based on their dates, photos selected by the user from photos which can be imported, and saves classified photos in a date album.

Upon creating the user album, the user inputs an album name to a text box 120 below the check box “group into album”. A predetermined album name displayed in the text box 120 is that created based on a date of import. The user can change this given album name to an arbitrary album name, and can create a user album. The content playback application 202 can create a user album with the album name changed by the user.

Also, the content playback application 202 can upload photos to be imported to the online storage site 20. When the user checks a check box “save copy on online storage” in FIG. 14, the content playback application 202 can import photos from the external device to the photo folder, and can upload the imported photos or a photo folder including the imported photos to an online storage of the online storage site 20.

Note that the content playback application 202 may upload, to the online storage site 20, an album of the same type as that of the album which saves the imported photos. For example, when the content playback application 202 saves the imported photos as a user album in the computer 10, that user album is also uploaded to the online storage site 20. Likewise, when the content playback application 202 saves the imported photos as a date album in the computer 10, that date album is also uploaded to the online storage site 20.

Note that a user album name to be uploaded may be that of a user album to be saved in the computer 10, but it may be changed to a name which allows the user to recognize that the user album is uploaded to the online storage site 20.

In FIG. 14, when the user selects an “OK” button 122 on the screen of FIG. 18, the content playback application 202 begins to import photos. On the other hand, when the user selects a “Cancel” button, the screen transits from the “import from external device” screen to the timeline display screen without importing any photo.

Also, thumbnail images 121b to 121f and the like are displayed in an import photo selection box 121. The user checks a check box corresponding to “select all” in FIG. 14, and can select photos to be saved in the photo folder from the import photo selection box 121. Note that in FIG. 14, a plurality of thumbnail images are displayed in the import photo selection box 121, but only one thumbnail image may be displayed. When the user does not check the check box corresponding to “select all”, photos which can be imported by the content playback application 202 when the external device is connected to the computer 10 (for example, photos corresponding to thumbnail images that can be displayed on the import photo selection box 121) are saved in the photo folder.

The case is described after photos to be imported by the content playback application 202 are decided on the “import from external device” screen shown in FIG. 14. Note that during a period in which data of the decided photos are sent from the external device to the computer 10, an import screen indicating the progress of import processing or the like may be displayed. When the import screen is displayed, for example, a button used to abort the import processing may be displayed on that screen. When the import processing is aborted, photos which have been imported before the abort timing are saved in the photo folder. Upon completion of the import processing of photos, a list of imported photos may be displayed on the thumbnail list screen shown in FIG. 9.

The content playback application 202 can import arbitrary photos saved in folders other than the photo folder to the photo folder. The content playback application 202 displays a file selection dialog box or the like on the screen. The user can select photos (image files) in an image file format in a folder other than the photo folder from the file selection dialog box. Note that photos selected from the folder other than the photo folder may be copied from the folder other than the photo folder to the photo folder. Upon importing photos included in the folder other than the photo folder, the content playback application 202 may display a button to call the file selection dialog box on the screen, and may display thumbnail images of the photos included in the folder other than the photo folder on the file selection dialog box.

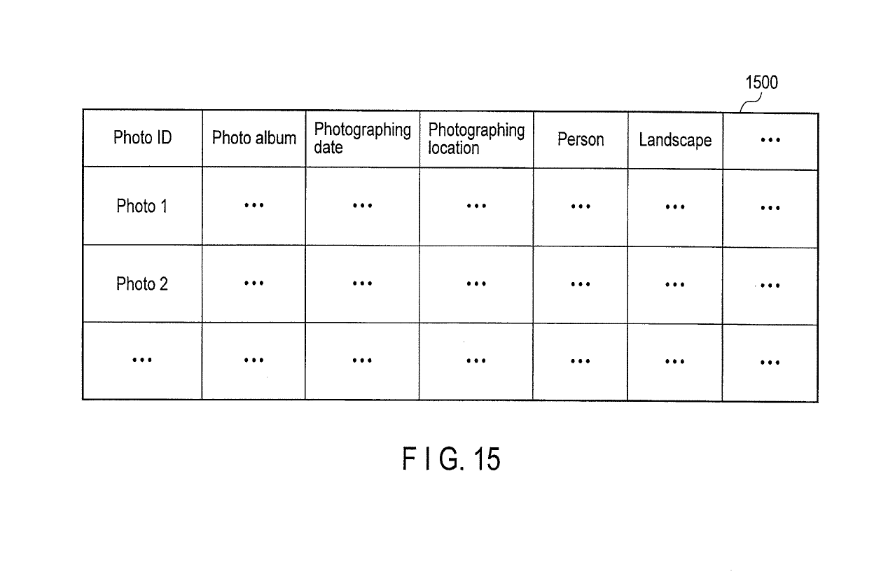

An example of a photo index information database table will be described below with reference to FIG. 15.

FIG. 15 shows an example of an index information database table which configures an index information database 1500. The index information database table 1500 includes a plurality of entries corresponding to a plurality of photos. Each entry includes fields corresponding to, for example, “photo ID”, “photo album”, “photographing date”, “photographing location”, “person”, “landscape”, and the like. In an entry corresponding to a certain photo, “photo ID” indicates identification information unique to that photo. “Photo album” indicates a name of an album having photos such as a user album, date album, or SNS album. “Photographing date” indicates a date on which that photo was taken. “Photographing location” indicates a location where the photo was taken or that where the photo was acquired. Note that the information of “photographing location” includes that such as a latitude or longitude of a photographing spot measured by GPS (Global Positioning System).

Note that “photographing date”, “photographing location”, and the like of the index information database 1500 are appended to a photo as metadata of that photo such as Exif (Exchangeable image file format). The Exif includes a type of a camera used in photographing, a type of a lens used by that camera, photographing conditions, or the like in addition to the aforementioned index information. Also, “person” and “landscape of the index information database 1500 are information obtained by executing clustering processing associated with faces or scenes.

As described above, according to the embodiment, when computer 10 moves while an image corresponding to a certain content data is displayed, an image corresponding to a content stored in another folder different from a folder which stores the currently displayed content is displayed. Therefore, for example, the user can browse an unexpected content every time he or she performs a predetermined operation (for example, every time he or she shakes the computer 10). Not only using the predetermined operation as a trigger for displaying a related content, but also using values of the sensors which detect the predetermined operation, an operation upon performing the predetermined operation can be changed. Since a photo related to a currently browsed content (photo) appears, the user can obtain a sense of expectation or a fun to browse photos as if he or she were tracing related photos every time he or she performs the predetermined operation. The user can find a new content every time he or she shakes the computer 10, thus promoting to browse contents. Also, the user can enjoy an operation itself of the computer.

All the processing procedures described in this embodiment can be implemented by software. It is therefore possible to easily achieve the same effects as those of the embodiment by only installing computer programs for executing these processing procedures in a general computer via a computer-readable storage medium storing the programs and executing computer programs.

In addition, the function of each module shown in FIGS. 4 and 5 may be implemented by hardware such as a custom LSI and DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
at least one sensor;
a display processor configured to display a first image corresponding to first content data stored in a first folder on a screen; and
a determiner configured to determine whether the electronic apparatus moves, using the at least one sensor,
wherein the display processor is further configured to display, on the screen, a second image corresponding to second content data stored in another folder different from the first folder, if it is determined that the electronic apparatus moves during display of the first image.

2. The apparatus of claim 1, wherein the determiner is further configured to determine that the electronic apparatus moves if the electronic apparatus is shaken in at least one direction.

3. The apparatus of claim 1, wherein the display processor is further configured to:
display, on the screen, an third image corresponding to third content data which is stored in said another folder and is related to the first content data in association with a first attribute, if it is determined that the electronic apparatus moves in a first direction during display of the first image, and
display, on the screen, an fourth image corresponding to fourth content data which is stored in the other folder and is related to the first content data in association with a second attribute different from the first attribute, if it is determined that the electronic apparatus moves in a second direction during display of the first image, wherein the second direction is different from the first direction.

4. The apparatus of claim 1, wherein the display processor is further configured to:
display, on the screen on which the first image corresponding to the first content data is displayed, the second image corresponding to the second content data in a first display fashion, and
display the second image corresponding to the second content data on the screen in a size larger than a size in the first display fashion when a user selects the second image corresponding to the second content data.

5. The apparatus of claim 1, wherein the display processor is further configured to select the second content data from a plurality of content data stored in the another folder using a detection value of the at least one sensor, if it is determined that the electronic apparatus moves during display of the first image.

6. The apparatus of claim 1,
wherein the display processor is further configured to display a plurality of second images corresponding to a plurality of second content data on the screen if the determiner determines using sensors in the apparatus that the electronic apparatus moves, the plurality of second content data being selected using a plurality of different criteria associated with the sensors.

7. The apparatus of claim 1, wherein the determiner is further configured to determine that the electronic apparatus moves if a detection value of the at least one sensor exceeds a threshold a predetermined number of times.

8. The apparatus of claim 1, wherein the display processor is further configured to display one or more images corresponding to one or more second content data on the screen, the number of the second content data being determined in accordance with a detection value of the at least one sensor.

9. The apparatus of claim 1, wherein the display processor is further configured to display, on the screen, an third image corresponding to third content data stored in another folder different from the folder in which the second content data is stored, if it is determined that the electronic apparatus moves during display of the second image.

10. An image display control method comprising:
displaying an first image corresponding to first content data stored in a first folder on a screen;
determining whether an electronic apparatus moves, using at least one sensor; and
displaying, on the screen, an second image corresponding to second content data stored in another folder different from the first folder, if it is determined that the electronic apparatus moves during display of the first image.

11. The image display control method of claim 10, wherein the determining comprises determining that the electronic apparatus moves if the electronic apparatus is shaken in at least one direction.

12. The image display control method of claim 10, further comprising:
displaying, on the screen, an third image corresponding to third content data which is stored in said another folder and is related to the first content data in association with a first attribute, if it is determined that the electronic apparatus moves in a first direction during display of the first image, and
displaying, on the screen, an fourth image corresponding to fourth content data which is stored in the other folder and is related to the first content data in association with a second attribute different from the first attribute, if it is determined that the electronic apparatus moves in a second direction during display of the first image, wherein the second direction is different from the first direction.

13. The image display control method of claim 10, wherein the displaying the second image comprises:
displaying, on the screen on which the first image corresponding to the first content data is displayed, the second image corresponding to the second content data in a first display fashion, and
displaying the second image corresponding to the second content data on the screen in a size larger than a size in the first display fashion when a user selects the second image corresponding to the second content data.

14. The image display control method of claim 10, further comprising selecting the second content data from a plurality of content data stored in the another folder using a detection value of the at least one sensor, if it is determined that the electronic apparatus moves during display of the first image.

15. A computer-readable, non-transitory storage medium having stored thereon a computer program which is executable by a computer, the computer program controlling the computer to execute functions of:
displaying an first image corresponding to first content data stored in a first folder on a screen;
determining whether the computer moves, using at least one sensor; and
displaying, on the screen, an second image corresponding to second content data stored in another folder different from the first folder, if it is determined that the computer moves during display of the first image.

16. The computer-readable, non-transitory storage medium of claim 15, wherein the determining comprises determining that the computer moves if the computer is shaken in at least one direction.

17. The computer-readable, non-transitory storage medium of claim 15, wherein the computer program further controls the computer to execute functions of:
displaying, on the screen, an third image corresponding to third content data which is stored in said another folder and is related to the first content data in association with a first attribute, if it is determined that the computer moves in a first direction during display of the first image, and
displaying, on the screen, an fourth image corresponding to fourth content data which is stored in the other folder and is related to the first content data in association with a second attribute different from the first attribute, if it is determined that the computer moves in a second direction during display of the first image, wherein the second direction is different from the first direction.

18. The computer-readable, non-transitory storage medium of claim 15, wherein the displaying the second image comprises:
displaying, on the screen on which the first image corresponding to the first content data is displayed, the second image corresponding to the second content data in a first display fashion, and
displaying the second image corresponding to the second content data on the screen in a size larger than a size in the first display fashion when a user selects the second image corresponding to the second content data.

19. The computer-readable, non-transitory storage medium of claim 15, wherein the computer program further controls the computer to execute a function of selecting the second content data from a plurality of content data stored in the another folder using a detection value of the at least one sensor, if it is determined that the electronic apparatus moves during display of the first image.
